(19) United States
(12) Patent Application Publication
(10) Pub. No.: US 2017/0278040 A1
(43) Pub. Date: Sep. 28, 2017

(54) MONITORING ACTIVITY TO DETECT POTENTIAL USER ACTIONS

(71) Applicant: International Business Machines Corporation, Armonk, NY (US)

(72) Inventors: Hernan A. Cunico, Holly Springs, NC (US); Asima Silva, Holden, MA (US)

(21) Appl. No.: 15/481,811

(22) Filed: Apr. 7, 2017

Related U.S. Application Data
(63) Continuation of application No. 15/081,122, filed on Mar. 25, 2016.

(51) Int. Cl. G06Q 10/06; G06K 9/00

(52) U.S. Cl. CPC G06Q 10/06398; G06K 9/00342; G06K 9/00335; G06K 9/00275; G06K 9/00302; G06Q 10/0639; G06Q 10/0635

(57) ABSTRACT

A method, a processing device, and a computer program product are provided. Collected information concerning monitored activities of a user are received. Activities with context may be processed based on one or more of verbal communications and written communications from the collected information. Sentiments of the user may be determined over time based on the collected information and the processed activities. The sentiments may be analyzed in order to identify a variation in the sentiments over time, which indicate a change in satisfaction of the user. An alert regarding an unsatisfied user may be provided in response to comparing the variation in the sentiments with a threshold. A recommendation to alleviate dissatisfaction of the user may be presented.

### CROSS REFERENCE TO RELATED APPLICATIONS

This application is a continuation of U.S. patent application Ser. No. 15/081,122, entitled “MONITORING ACTIVITY TO DETECT POTENTIAL USER ACTIONS” and filed Mar. 25, 2016, the disclosure of which is incorporated herein by reference in its entirety.

### BACKGROUND

Present invention embodiments are related to systems and methods for detecting potential user actions. In particular, present invention embodiments are related to monitoring activities, determining user satisfaction based on the monitoring, generating a report or alert, and making recommendations for increasing satisfaction.

One existing system monitors an employee's activities such as, for example, Internet searches on job sites and online applications for jobs, mobile device telecom usage, telephone activity, human resources data and employee demographic data to infer that an employee is dissatisfied with his/her current job.

In another existing system, sentiment analysis is performed based on comments. Web crawlers are employed to scope the sentiment analysis per platform such as, for example, Facebook, YouTube, and general web browsing as well as manual collections.

However, neither of the above-mentioned systems employ natural language processing of text and speech as well as video and photographic information of the user to infer that a user is dissatisfied with his/her current job.

### SUMMARY

According to embodiments of the present invention, a method, a processing device, and a computer program product are provided. A user's activities may be monitored, via at least one device, to collect information. Activities with context may be processed by at least one processing device based on one or more of verbal communications and written communications from the collected information. The at least one processing device may determine sentiments of the user over time based on the collected information and the processed activities. The at least one processing device may analyze the sentiments to identify a variation in the sentiments of the user over time, which indicate a change in satisfaction of the user. The at least one processing device may provide an alert with respect to an unsatisfied user in response to comparing the variation with a threshold

### BRIEF DESCRIPTION OF THE DRAWINGS

Generally, like reference numerals in the various figures are utilized to designate like components.

FIG. 1 illustrates an example environment in which embodiments may be implemented.

FIG. 2 illustrates an example processing device for implementing various embodiments.

FIG. 3 is a functional block diagram indicating processing carried out in an example embodiment.

FIG. 4 is a flowchart, which explains example processing in various embodiments.

### DETAILED DESCRIPTION

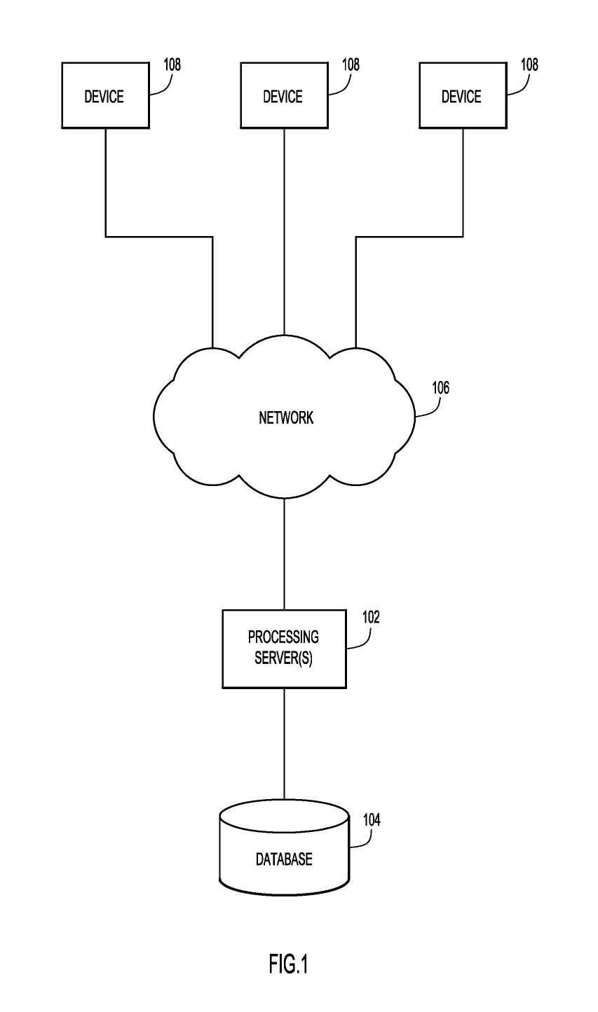

With reference now to FIG. 1, an example environment for implementation of embodiments is shown. One or more processing servers 102 may have access to database 104. Multiple processing servers 102 may be configured, in some embodiments, to act as a server farm. One or more processing servers 102 may be connected to network 106, which may be a wired or wireless network or a combination thereof. One or more devices 108 may access database 104 via network 106 and one or more processing servers 102. The devices may include, but not be limited to, a personal computer, a laptop, a mobile communication device, a video teleconferencing system, etc.

Network 106 may be implemented by any number of any suitable communications media (e.g., wide area network (WAN), local area network (LAN), Internet, Intranet, etc.). Alternatively, one or more processing servers 102 and devices 108 may be local to each other, and may communicate via any appropriate local communication medium (e.g., local area network (LAN), hardwire, wireless link, Intranet, etc.).

Devices 108 may provide information including, but not limited to, video or photographic information, textual information, and voice information to one or more processing servers 102. Database 104 may store collected information and information for other database system operations. Database 104 may be implemented by any conventional or other database or storage unit, may be local to or remote from one or more processing servers 102 and devices 108, and may communicate via any appropriate communication medium (e.g., local area network (LAN), wide area network (WAN), Internet, hardwired, wireless link, Intranet, etc.).

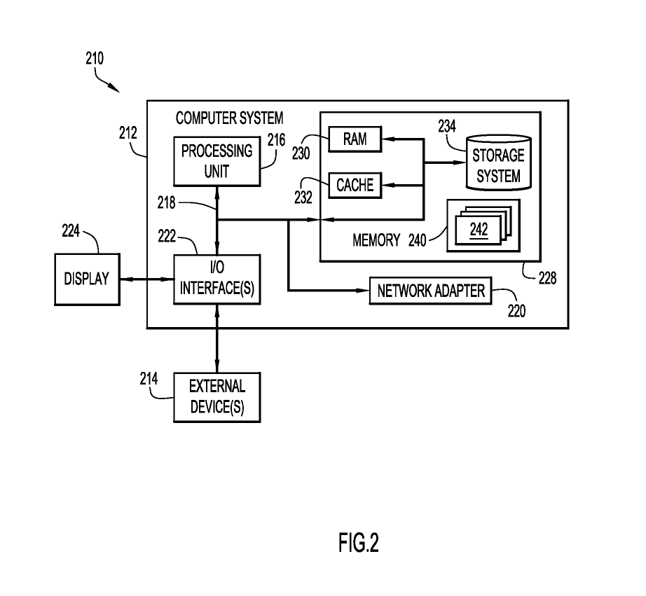

Referring now to FIG. 2, a schematic of an example of a processing device 210, which may implement user device 108 or each of one or more processing servers 102 of environment 100, is shown. Processing device 210 is only one example of a suitable processing device for the environment of FIG. 1 and is not intended to suggest any limitation as to the scope of use or functionality of embodiments of the invention described herein. Regardless, processing device 210 is capable of being implemented and/or performing any of the functionality set forth herein.

In processing device 210, there is a computer system 212 which is operational with numerous other general purpose or special purpose computing system environments or configurations. Examples of well-known computing systems, environments, and/or configurations that may be suitable for use with computer system 212 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system 212 may be described in the general context of computer system executable instructions, such as program modules, being executed by a computer system. Generally, program modules may include routines, programs, objects, components, logic, data structures, and so on that perform particular tasks or implement particular abstract data types. Computer system 212 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 2, computer system 212 is shown in the form of a general-purpose computing device. Components of computer system 212 may include, but are not limited to, one or more processors or processing units 216, a system memory 228, and a bus 218 that couples various system components including system memory 228 to processor 216.

Bus 218 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system 212 typically includes a variety of computer system readable media. Such media may be any available media that is accessible by computer system 212, and it includes both volatile and non-volatile media, removable and non-removable media.

System memory 228 can include computer system readable media in the form of volatile memory, such as random access memory (RAM) 230 and/or cache memory 232. Computer system 212 may further include other removable/non-removable, volatile/non-volatile computer system storage media. By way of example only, storage system 234 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 218 by one or more data media interfaces. As will be further depicted and described below, memory 228 may include at least one program product having a set (e.g., at least one) of program modules that are configured to carry out the functions of embodiments of the invention.

Program/utility 240, having a set (at least one) of program modules 242, may be stored in memory 228 by way of example, and not limitation, as well as an operating system, one or more application programs, other program modules, and program data. Each of the operating system, one or more application programs, other program modules, and program data or some combination thereof, may include an implementation of a networking environment. Program modules 242 generally carry out the functions and/or methodologies of embodiments of the invention as described herein.

Computer system 212 may also communicate with one or more external devices 214 such as a keyboard, a pointing device, a display 224, etc.; one or more devices that enable a user to interact with computer system 212; and/or any devices (e.g., network card, modem, etc.) that enable computer system 212 to communicate with one or more other computing devices. Such communication can occur via Input/Output (I/O) interfaces 222. Still yet, computer system 212 can communicate with one or more networks such as a local area network (LAN), a general wide area network (WAN), and/or a public network (e.g., the Internet) via network adapter 220. As depicted, network adapter 220 communicates with the other components of computer system 212 via bus 218. It should be understood that, although not shown, other hardware and/or software components could be used in conjunction with computer system 212. Examples, include, but are not limited to: microcode, device drivers, redundant processing units, external disk drive arrays, RAID systems, tape drives, and data archival storage systems, etc.

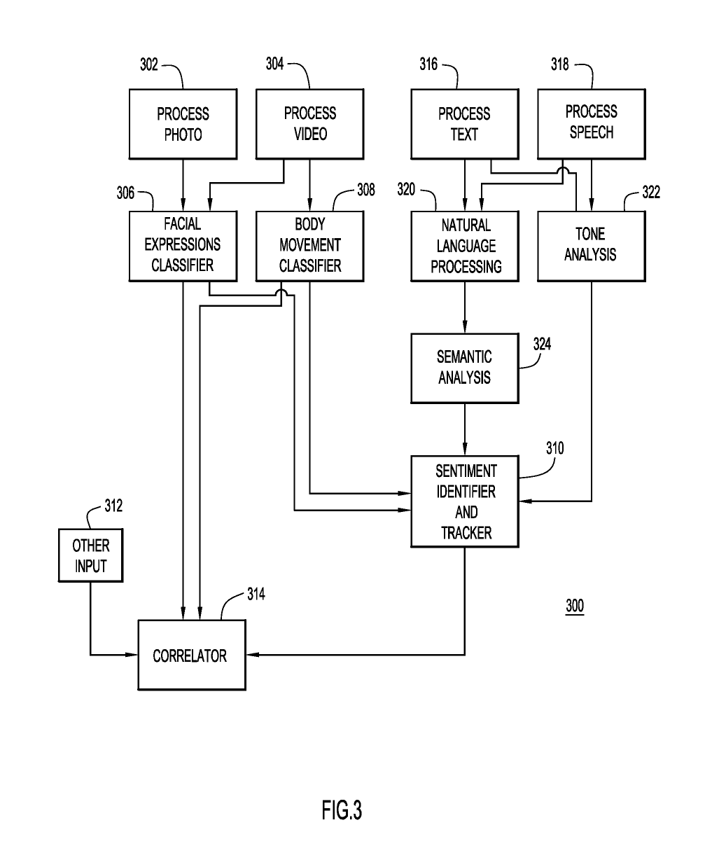

FIG. 3 is a functional block diagram of an example system 300, which may include one or more processing devices, including, but not limited to, one or more processing servers 102, device(s) 108, or other processing devices. System 300 may process photos 302 and videos 304 from any of devices 108 or other devices. A facial expressions classifier 306 may analyze and classify a facial expression included in a processed photo and/or a processed video using any conventional method. A body movement classifier 308 may analyze and classify body movements in the processed video using any conventional method. For example, rapid and abrupt body movements may indicate dissatisfaction. Therefore, facial and body movement classifications may be performed by various conventional image processing or other techniques.

The system may receive and process text 316 and speech 318 from any of devices 108 as well as other devices. The text may be from emails, text messages, and social media communications as well as other communications. The speech may be recognized and the text and the recognized speech may be processed by natural language processing 320 to derive meaning from the text and the recognized speech. This may be performed by using conventional techniques such as, converting chunks of text into more formal representations such as first-order logic structures that are easier for computer programs to manipulate.

Natural language understanding involves the identification of the intended semantic from the multiple possible semantics which can be derived from a natural language expression which usually takes the form of organized notations of natural languages concepts. The recognized speech may be processed by tone analysis 322, which may analyze a tone of the natural language from the recognized speech using conventional techniques. Examples of tone may include, but not be limited to, abrupt, angry, unhappy, sarcastic, etc. Results of natural language processing 320, which may be first order logic structures as mentioned above, may be provided to semantic analysis 324, which may provide results to sentiment identifier and tracker 310. Sentiment identifier and tracker 310 may identify a sentiment from the results of the semantic analysis through conventional techniques and may track changes in the identified sentiments to determine a trend. A range of emotions, or sentiments may be quite large and diverse and may include, but not be limited to, happy, angry, secure, confused, as well as many others. Results of tone analysis 322 may also be provided to sentiment identifier and tracker 310 and taken into consideration when identifying the sentiment.

Correlator 314 may receive, as inputs, outputs of sentiment identifier and tracker 310, facial expressions classifier 306, body movement classifier 308, and tone analysis 322. Correlator 314 may also receive other input 312 such as, for example, human resource information including, but not limited to, current assignments, length of current assignments, skill levels, skill levels required by current assignments, and personality type assessment. Correlator 314 may use conventional techniques to correlate its inputs and may produce a report including recommendations for improving employee satisfaction.

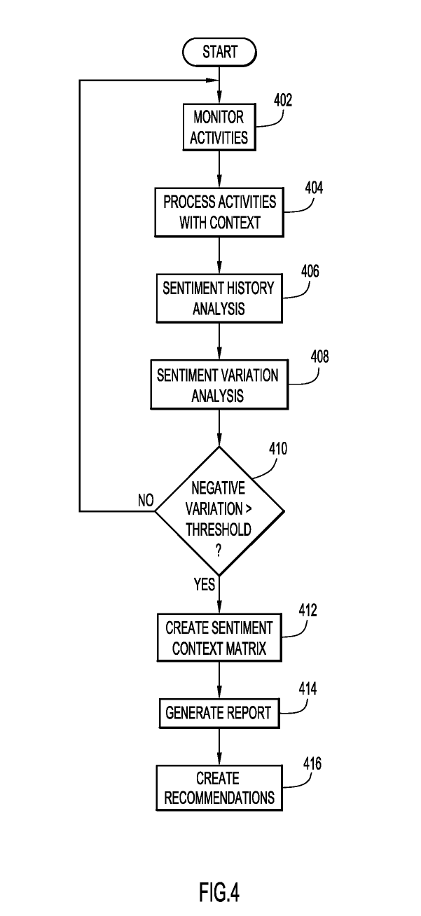

FIG. 4 is a flowchart that illustrates example processing in an embodiment. The process may begin with monitoring an employees activities (act 402). A number of devices 108 may be provided with an agent for collecting information. The agent may perform a number of activities depending on functions of devices 108. Types of activities that the agent may perform include, but are not limited to, taking one or more photos of the employee, taking a video of the employee, collecting text messages, emails and social media communications between the employee and others, and collecting speech of the employee. Information from the monitored activities may be provided to one or more processing servers 102 for processing with context provided by processing speech and text (act 404). In alternate embodiments, at least some of the processing may be performed by devices 108 and by one or more processing servers 102. Therefore, in some embodiments, one or more processing servers 102 may perform classification of facial expressions with respect to photos, body movement classification with respect to videos, natural language processing and tone analysis with respect to text and speech, and semantic analysis with respect to the natural language processing. In alternate embodiments, devices 108 may perform at least some of the above-mentioned processing including at least one of, but not limited to, facial expression classification of photos, body movement classification of videos, natural language processing and tone analysis of text and/or speech, and semantic analysis with respect to processed natural language speech and/or text.

One or more processing servers 102 may then perform sentiment identification and tracking, which may include, but not be limited to sentiment history analysis 406 to determine any patterns with respect to any detected dissatisfaction (act 406), and sentiment variation analysis to determine whether any detected dissatisfaction is increasing or decreasing over time (act 408).

Aggregation of sentiments over a given time period may be used to calculate a satisfaction quotient. The satisfaction quotient may be mathematically calculated by assigning weights to sentiments and adding or subtracting the satisfaction quotients. Not all sentiments may have equal weight and a same sentiment may have different weights depending on a triggering event. The weights may be adjusted by a company or by a user being monitored.

In addition, the determined sentiment may be recorded and annotated with surrounding factors from database 104. Over time, a contextual map with sentiments of the employee may be created and recorded, as well as additional information of contextual events that may have had an effect on the sentiment of the employee.

Next, one or more processing servers 102 may determine whether a negative variation threshold was exceeded (act 410). Determining whether a negative variation threshold was exceeded may take into account a number of factors, including, but not limited to, a number of consecutive times satisfaction declined for a group or an individual, duration of the dissatisfaction, context surrounding the dissatisfaction, repeating factors that may be causing the satisfaction (for example, software being used, interactions with a particular person, type of job or assignment, required skill level etc.), and time of year (for example, time for self assessments).

If the negative variation threshold was exceeded, then one or more processing servers 102 may create an abstraction map between sentiment, associated communication, and subsequent activity and may perform a secondary analysis, which may include, but not be limited to, performing a specific analysis on a personality type of an affected employee and, if applicable, of other involved individuals, and may further include information pertaining to monitored activities indicating dissatisfaction (act 412). The abstraction map may keep track of:
a. timing;
b. an involved communication channel (mail, text message, phone call, social media communication, etc.);
c. style and tone of the communication (direct, aggressive, command, confusing, etc.);
d. type of communication (formal, informal);
e. type of activity;
f. software involved;
g. people involved; and personality type of the people involved.

One or more processing servers 102 may generate an alert or report indicating probable causes of dissatisfaction (act 414) determined from the abstraction map (e.g., context or activities of the dissatisfaction, etc.), and may create, or generate, recommendations for alleviating or eliminating the dissatisfaction (act 416). Recommendations may include, but not be limited to, changing the employee's assignments, suggesting the employee apply for another position with employer, providing the employee with more responsibility, etc.

In alternative embodiments, the abstraction map may be created before the negative variation threshold is exceeded. In one embodiment, sentiment analysis and mapping may be performed in a circular manner and on an ongoing basis. When the negative variation threshold is reached, action may be taken such as, for example, creating a report and so on.

The environment of the present invention embodiments may include any number of computer or other processing systems (e.g., client or end-user systems, server systems, etc.) and databases or other repositories arranged in any desired fashion, where the present invention embodiments may be applied to any desired type of computing environment (e.g., cloud computing, client-server, network computing, mainframe, stand-alone systems, etc.). The computer or other processing systems employed by the present invention embodiments may be implemented by any number of any personal or other type of computer or processing system (e.g., desktop, laptop, PDA, mobile devices, etc.), and may include any commercially available operating system and any combination of commercially available and custom software (e.g., browser software, communications software, server software, etc.). These systems may include any types of monitors and input devices (e.g., keyboard, mouse, voice recognition, etc.) to enter and/or view information.

It is to be understood that the software of the present invention embodiments may be implemented in any desired computer language and could be developed by one of ordinary skill in the computer arts based on the functional descriptions contained in the specification and flowcharts illustrated in the drawings. Further, any references herein of software performing various functions generally refer to computer systems or processors performing those functions under software control. The computer systems of the present invention embodiments may alternatively be implemented by any type of hardware and/or other processing circuitry.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., LAN, WAN, Intranet, Internet, hardwired, modem connection, wireless, etc.). For example, the functions of the present invention embodiments may be distributed in any manner among the various end-user/client and server systems, and/or any other intermediary processing devices. The software and/or algorithms described above and illustrated in the flowcharts may be modified in any manner that accomplishes the functions described herein. In addition, the functions in the flowcharts or description may be performed in any order that accomplishes a desired operation.

The software of the present invention embodiments may be available on a non-transitory computer useable medium (e.g., magnetic or optical mediums, magneto-optic mediums, floppy diskettes, CD-ROM, DVD, memory devices, etc.) of a stationary or portable program product apparatus or device for use with stand-alone systems or systems connected by a network or other communications medium.

The communication network may be implemented by any number of any type of communications network (e.g., LAN, WAN, Internet, Intranet, VPN, etc.). The computer or other processing systems of the present invention embodiments may include any conventional or other communications devices to communicate over the network via any conventional or other protocols. The computer or other processing systems may utilize any type of connection (e.g., wired, wireless, etc.) for access to the network. Local communication media may be implemented by any suitable communication media (e.g., local area network (LAN), hardwire, wireless link, Intranet, etc.).

The system may employ any number of any conventional or other databases, data stores or storage structures (e.g., files, databases, data structures, data or other repositories, etc.) to store information. The database system may be implemented by any number of any conventional or other databases, data stores or storage structures (e.g., files, databases, data structures, data or other repositories, etc.) to store information. The database system may be included within or coupled to the server and/or client systems. The database systems and/or storage structures may be remote from or local to the computer or other processing systems, and may store any desired data.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising”, “includes”, “including”, “has”, “have”, “having”, “with” and the like, when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

We claim as our invention:

1. A computer-implemented method of detecting potential user actions comprising:
monitoring, via at least one device, activities of a user and collect information;
processing, by at least one processing device, activities with context based on at least one of verbal communications and written communications from the collected information;
determining, by the at least one processing device, sentiments of the user over time based on the collected information and the processed activities;
analyzing, by the at least one processing device, the sentiments to identify a variation in the sentiments of the user over time indicating a change in satisfaction of the user; and
providing, by the at least one processing device, an alert of an unsatisfied user in response to a comparison of the variation with a threshold.

2. The method of claim 1, wherein the monitored activities include at least one of body movements and facial expressions.

3. The method of claim 1, further comprising:
determining the context in which a sentiment of the user is occurring based on the monitoring and the processing; and
identifying the context associated with the variation to determine at least one cause of the variation.

4. The method of claim 1, further comprising:
responsive to determining that the user is dissatisfied:
analyzing a personality type of the user to produce a personality type analysis;
correlating the sentiment, the personality type analysis, the processed activities with context, and the monitored activities; and
generating a recommendation to increase satisfaction of the user based on the correlating.

5. The method of claim 4, wherein the correlating identifies at least one event that causes dissatisfaction of the user.

6. The method of claim 4, wherein the sentiment is associated with employment of the user.

7. The method of claim 6, wherein the recommendations pertain to actions to retain the employment of the user.
